(19) United States
(12) Patent Application Publication
(10) Pub. No.: US 2013/0247021 A1
(43) Pub. Date: Sep. 19, 2013

(54) ELECTRONIC DEVICE, SYSTEM AND METHOD FOR UPDATING AND UNINSTALLING SOFTWARE

(71) Applicant: QIANG YOU, Shenzhen City (CN)

(72) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/570,272

(22) Filed: Aug. 9, 2012

(30) Foreign Application Priority Data
Mar. 13, 2012 (CN) 201210064660.7

(51) Int. Cl. G06F 9/44

(52) U.S. Cl. 717/169

(57) ABSTRACT

A method for uninstalling and updating software is provided. The method includes: detecting that whether there is at least one icon displayed in the uninstall area or the update area. If there is the icon displayed in the uninstall area, determining a software corresponding to the icon displayed in the uninstall area; and controlling to uninstall the software. If there is the icon displayed in the update area, determining a software corresponding to the icon displayed in the update area; and controlling to update the software.

### BACKGROUND

1. Technical Field

The present disclosure relates to electronic devices, particularly, to an electronic device, a system and a method for updating and uninstalling software.

2. Description of Related Art

Nowadays, electronic devices, such as computers, and smart phones usually come prepackaged with selected software. The usual method to install or update the software requires a special control interface command to be entered, it may be hard for the user of the electronic device to find the control interface or maybe the user needs to perform many operations to enter the control interface.

An electronic device, a system, a method for installing and updating software to overcome the described limitations is thus needed.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a system for updating and uninstalling software, in accordance with an exemplary embodiment.

FIG. 2 is a schematic diagram showing an electronic device applying the system of FIG. 1, in accordance with an exemplary embodiment.

FIG. 3 is a schematic diagram showing an operation for updating or uninstalling a software executed on an interface of the electronic device of FIG. 2, in accordance with an exemplary embodiment.

FIG. 4 is a schematic diagram showing the interface of the electronic device of FIG. 2, after updating or uninstalling the software, in accordance with an exemplary embodiment.

FIG. 5 is a block diagram showing an application management software of the electronic device of FIG. 2, in accordance with an exemplary embodiment.

FIG. 6 is a flowchart illustrating a method for updating and uninstalling software, in accordance with an exemplary embodiment.

### DETAILED DESCRIPTION

Embodiments of the present disclosure will be described, with reference to the accompanying drawings.

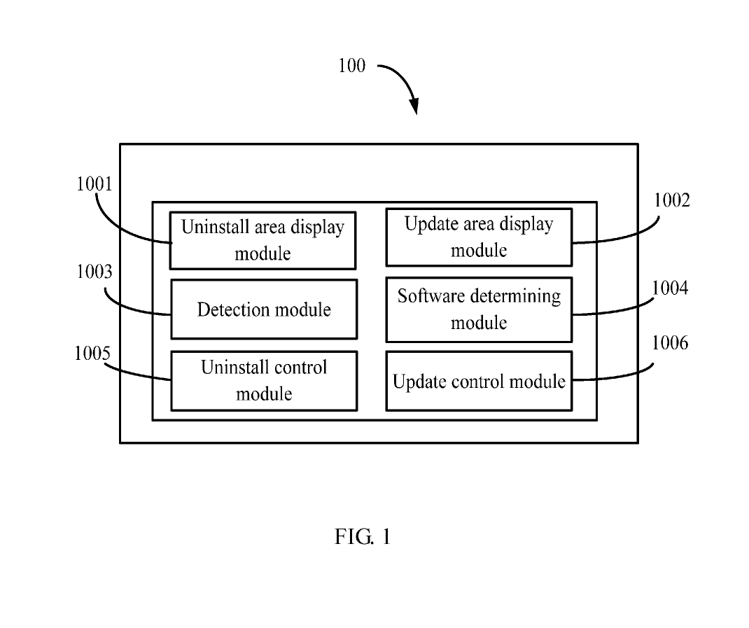

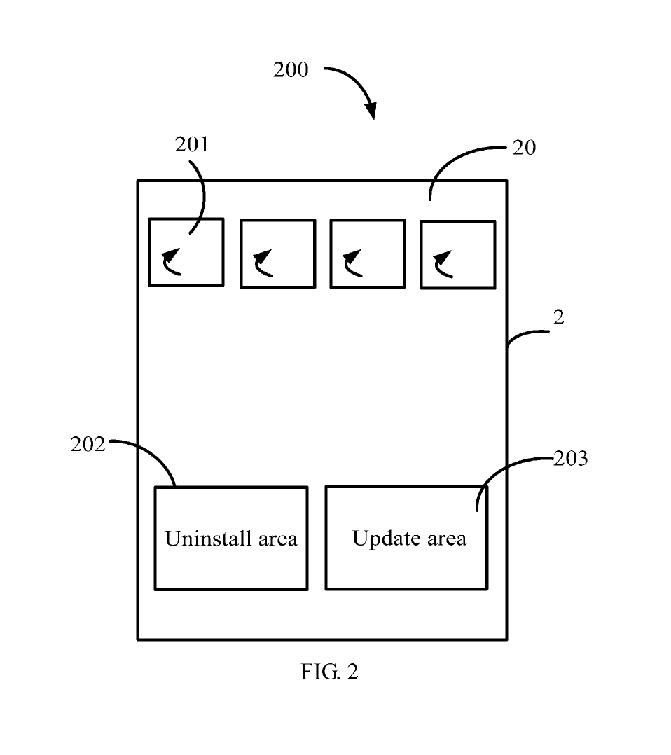

FIGS. 1 and 2, illustrate a system 100 in accordance with an embodiment. The system 100 updates and uninstalls software in an electronic device 200 as shown in FIG. 2. The electronic device 200 has been installed with at least one application software, such as a calculator, or a browser, for example. Each installed software is associated with an icon, when one software is installed in the electronic device 200, a corresponding icon can be displayed on an interface 20 which is displayed on a display unit 2, such as a desktop interface displayed on the display unit 2, of the electronic device 200. In the embodiment, the electronic device 200 can be a desktop computer, a portable computer, a tablet computer, or a smart phone, for example.

As shown in FIG. 1, the system 100 includes an uninstall area display module 1001, an update area display module 1002, a detection module 1003, a software determining module 1004, an uninstall control module 1005, and an update control module 1006.

The uninstall area display module 1001 is used to display an uninstall area 202 on the interface 20 as shown in FIG. 2. The update area display module 1002 is used to display an update area 203 on the interface 20.

The detection module 1003 is used to detect if there is at least one icon displayed in the uninstall area 202 or the update area 203. If the detection module 1003 detects that there is an icon displayed in the uninstall area 202 or the update area 203, the software determining module 1004 determines a software corresponding to the icon displayed in the uninstall area 202 or the update area 203. In detail, the electronic device 200 stores a relationship table recording relationships between the installed software and icons. Typically, when software is installed in the electronic device 200, a relationship between the installed software and its icon is stored in the relationship table. Accordingly, the software determining module 1004 determines the software corresponding to the icon according to the relationship table.

The uninstall control module 1005 controls to uninstall the software if the icon corresponding to the software is displayed in the uninstall area 202. The update control module 1006 controls to update the software if the icon corresponding to the software is displayed in the update area 203. Obviously, if the software is the newest version, the update control module 1006 does not update the software.

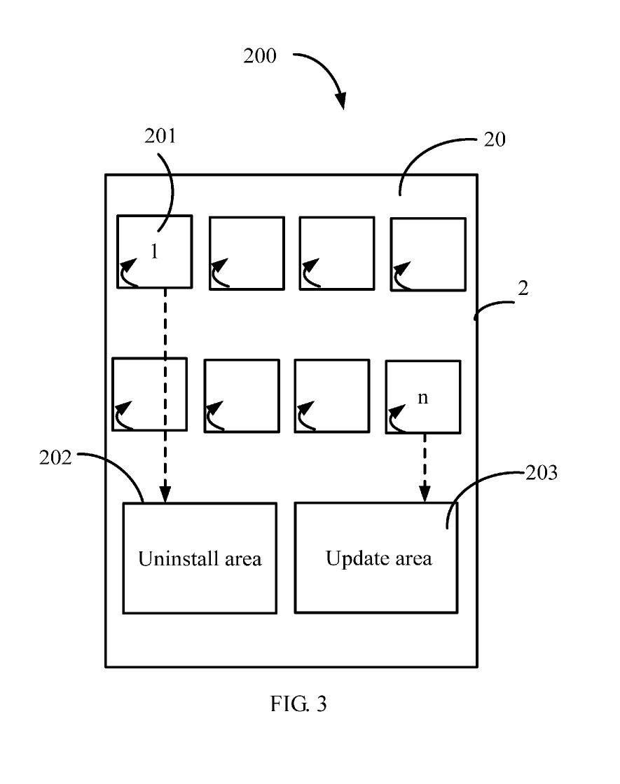

For example, as shown in FIG. 3, the interface 20, such as the desktop interface, displayed on the display unit 2 of the electronic device 200 displays the uninstall area 202, the update area 203, and a number of icons 201. If a user moves an icon 201 to the uninstall area 202, that means the user wants to uninstall the software corresponding to the moved icon 201, then the detection module 1003 detects that there is an icon displayed in the uninstall area 202, the software determining module 1004 determines the software corresponding to the icon is displayed in the uninstall area 202 accordingly. Then the uninstall control module 1005 controls to uninstall the software. If the user moves an icon 201 to the update area 203, that means the user wants to update the software corresponding to the moved icon 201, then the detection module 1003 detects that there is an icon displayed in the update area 203, the software determining module 1004 determines the software corresponding to the icon displayed in the update area 203. Then the update control module 1006 controls to update the software.

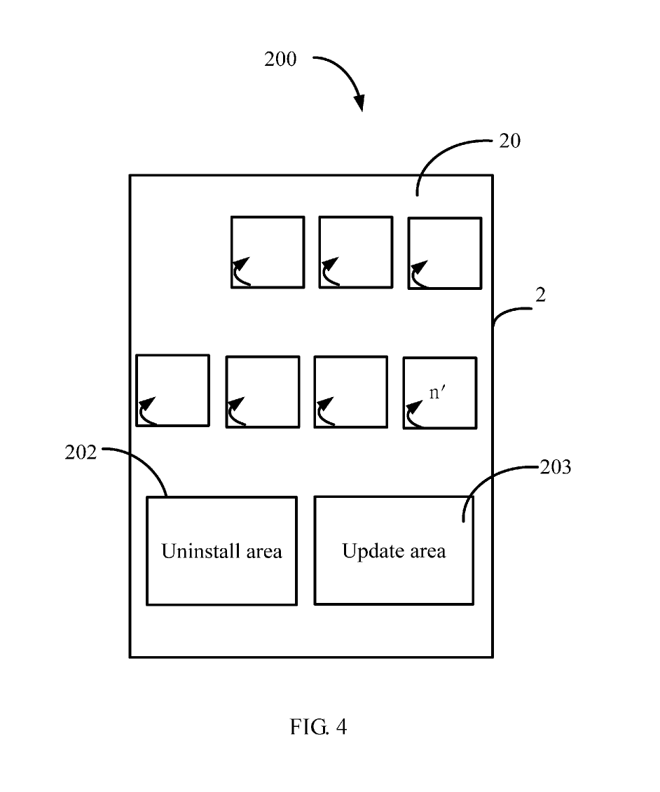

As shown in FIG. 4, when a software is uninstalled, the icon corresponding to the software is deleted from the interface 20, when a software N is updated to its newest version N′, then a new shortcut replaces the previous icon of the software N is displayed on the interface 20.

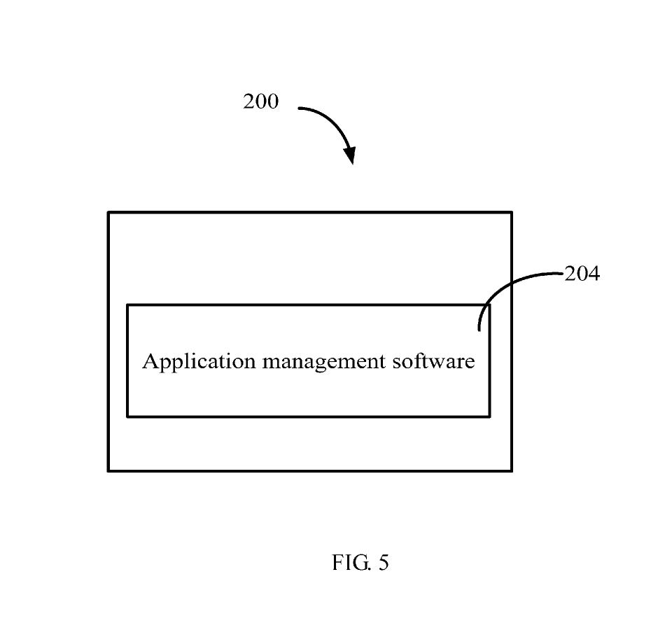

FIG. 5 illustrates that in the embodiment, the electronic device 200 has been packaged with an application management software 204. The application management software 204 is used to manage the operation of updating the installed software, uninstalling the installed software, and installing the software that needs to be installed to the electronic device 200. The uninstall control module 1005 controls the application management software 204 to execute an uninstall operation to uninstall the software and the update control module 1006 controls the application management software 204 to execute an update operation to update the software. The application management software 204 is also used to detect whether the software installed in the electronic device 200 needs to be updated at intervals, and prompt the user to update the software.

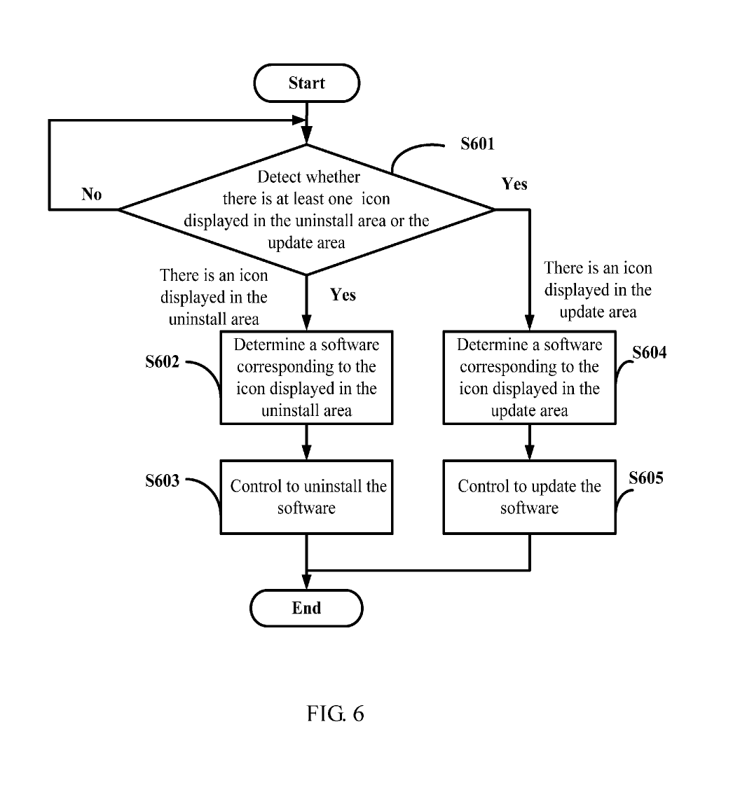

Referring to FIG. 6, a flowchart illustrating a method for updating and uninstalling software is shown. In step S601, the detection module 1003 detects whether there is at least one icon displayed in the uninstall area 202 or the update area 203.

If the detection module 1003 detects that there is the icon displayed in the uninstall area 202, in step S602, the software determining module 1004 determines a software corresponding to the icon displayed in the uninstall area 202.

In step S603, the uninstall control module 1005 controls to uninstall the software.

If the detection module 1003 detects that there is the icon displayed in the update area 203, in step S604, the software determining module 1004 determines a software corresponding to the icon displayed in the update area 203.

In step S605, the update control module 1006 controls to update the software.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A system for updating and uninstalling software, the system comprising:
a display unit to display an interface comprising an uninstall area;
an uninstall area display module, configured to display the uninstall area on the interface of the display unit, wherein, the interface of the display unit further displays a plurality of icons corresponding to different software installed in an electronic device;
a detection module, configured to detect that whether there is at least one first icon of the plurality of icons displayed in the uninstall area;
a software determining module, configured to determine at least one first software of the different software corresponding to the at least one first icon displayed in the uninstall area if the detection module determines that the at least one first icon is displayed in the uninstall area; and
an uninstall control module, configured to control to uninstall the at least one first software determined by the software determining module.

2. The system according to claim 1, further comprising an update area display module and an update control module; wherein the interface further comprising an update area, and:
the update area display module is configured to display the update area on the interface of the display unit; the detection module is further configured to detect that whether there is at least one second icon of the plurality of icons displayed in the update area; the software determining module is further configured to determine at least one second software of the different software corresponding to the at least one second icon displayed in the update area if the detection module determines that the at least one second icon is displayed in the update area; the update control module is configured to control to update the at least one second software determined by the software determining module.

3. The system according to claim 2, wherein the uninstall control module controls an application management software installed in the electronic device to uninstall the at least one first software, the update control module controls the application management software to update the at least one second software.

4. An electronic device, comprising:
a plurality of software installed in the electronic device;
a display unit to display an interface comprising an uninstall area and a plurality of icons respectively corresponding to the plurality of installed software; and
a system comprising:
an uninstall area display module, configured to display the uninstall area on the interface of the display unit;
a detection module, configured to detect that whether there is at least one first icon of the plurality of icons displayed in the uninstall area;
a software determining module, configured to determine at least one first software of the different software corresponding to the at least one first icon displayed in the uninstall area if the detection module determines that the at least one first icon is displayed in the uninstall area; and
an uninstall control module, configured to control to uninstall the at least one first software determined by the software determining module.

5. The electronic device according to claim 4, wherein the system further comprises an update area display module and an update control module; the update area display module is configured to display an update area on the interface of the electronic device; the detection module is further configured to detect that whether there is at least one second icon of the plurality of icons displayed in the update area; the software determining module is further configured to determine at least one second software of the different software corresponding to the at least one second icon displayed in the update area if the detection module determines that the at least one second icon is displayed in the update area; the update control module is configured to control to update the at least one second software determined by the software determining module.

6. The electronic device according to claim 5, wherein the electronic device has installed an application management software, the uninstall control module controls the application management software to uninstall the at least one first software, the update control module controls the application management software to update the at least one second software.

7. A method for uninstalling and updating software comprising:
detecting whether there is at least one first icon displayed in an uninstall area, wherein, the uninstall area is displayed on an interface of an electronic device installing a plurality of software;
determining at least one first software of the plurality of software corresponding to the at least one first icon displayed in the uninstall area if the at least one first icon is displayed in the uninstall area; and
controlling to uninstall the at least one first software.

8. The method according to claim 7, wherein the step of controlling to uninstall the first software comprises:
controlling an application management software to uninstall the at least one first software.

9. The method according to claim 7, further comprising:
detecting whether there is at least one second icon displayed in an update area, wherein, the update area is also displayed on the interface of the electronic device;
determining at least one second software corresponding to the at least one second icon displayed in the update area if the at least one second icon is displayed in the update area;
controlling to update the at least one second software.

10. The method according to claim 9, wherein the step of controlling to update the at least one second software comprises:
controlling an application management software to update the at least one second software.
